(19) United States
(12) Patent Application Publication
(10) Pub. No.: US 2013/0050396 A1
(43) Pub. Date: Feb. 28, 2013

(54) COMMUNICATION METHOD FOR VIDEO DATA

(71) Applicant: Ling Zhu, Su Zhou City (CN)

(72) Inventor: Ling Zhu, Su Zhou City (CN)

(73) Assignee: SERNET (SUZHOU) TECHNOLOGIES CORPORATION, JIANGSU (CN)

(21) Appl. No.: 13/587,004

(22) Filed: Aug. 16, 2012

(30) Foreign Application Priority Data
Aug. 22, 2011 (CN) 201110241589.0

(51) Int. Cl. H04N 7/14

(52) U.S. Cl. 348/14.02; 348/E07.082

(57) ABSTRACT

A communication method for video data is provided. A user equipment obtains contact information of a femtocell. The contact information includes a telephone number or a network telephone account registered to a core network by the femtocell. The user equipment requests the femtocell for a video telephone call via the core network. When the video telephone call is accepted, the user equipment receives the video data from the network camera connected to the femtocell via the core network.

This application claims the benefit of People's Republic of China application Serial No. 201110241589.0, filed Aug. 22, 2011, the subject matter of which is incorporated herein by reference.

### BACKGROUND

1. Technical Field

The application relates in general to a communication method for video data.

2. Description of the Related Art

Video monitoring systems are prevalent in various occasions including commercial establishments, financial facilities, factories and household environments. A video monitoring system usually utilizes a video camera to capture still images or dynamic videos to reinforce security of an environment under monitor.

A network camera, also referred to as a network monitoring camera, is common. A network monitoring camera transmits or receives data through the Internet. Generally speaking, through an Internet Protocol (IP) address of a network camera, real-time images or videos captured by the network camera can be observed by a remote user. Thus, user is allowed to allocate the network camera and/or access images captured by a network camera through the Internet based on IP address even when the user is at outdoor.

It should be noted that an IP address of the network camera is a dynamic IP address. That is, a new IP address is designated to the network camera each time the network camera connects to the Internet. Therefore, a user is faced with utilization inconveniences since the user is required to obtain a new-designated IP address when one wishes to access images captured by the network camera.

### SUMMARY OF THE APPLICATION

The application is directed to a communication method for video data, so as to allow a user to request for images captured by a network camera through a video telephone call to a femtocell to further enhance ease of use.

According to an example of the present application, a communication method for video data is provided. A user equipment obtains contact information of a femtocell. The contact information includes a telephone number or a network telephone account registered to a core network by a femtocell. According to the contact information, the user equipment requests the femtocell for a video telephone call. When the video telephone call is accepted, the user equipment receives video data captured by a network camera connected to the femtocell via the core network.

According to another example of the present application, a communication method for video data is further provided. A user equipment first accepts a video telephone call requested by a femtocell via a core network. The user equipment requests the femtocell for the video telephone call according to contact information of the femtocell. The contact information includes a telephone number or a network telephone account of the femtocell registered to the core network. The femtocell then accepts the video telephone call. When the video telephone call is accepted, video data captured by a network camera connected to the femtocell is transmitted to the user equipment by the femtocell via the core network.

The above and other contents of the application will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a communication system.

FIG. 2 is a flowchart of a communication method according to one embodiment of the present application.

FIG. 3 is an example of a detailed flowchart of the communication method in FIG. 2.

FIG. 4 is a flowchart of a communication method according to another embodiment of the present application.

FIG. 5 is a flowchart of a communication method according to another embodiment of the present application.

FIG. 6 is a flowchart of a communication method according to yet another embodiment of the present application.

### DETAILED DESCRIPTION OF THE APPLICATION

The application will be understood with regard to the following detailed description of the preferred but non-limiting embodiments. Unnecessary elements of the embodiments are omitted in the diagrams to demonstrate technical characteristics of the present application.

A communication method according to embodiments of the present application shall be given below. In one embodiment, a femtocell locates a network camera and accesses video data (captured by the network camera) from the network camera according to an Internet Protocol (IP) address of the network camera. The femtocell registers a telephone number or a network telephone account to a core network, based on which a user equipment may request for a video telephone call. Therefore, the user equipment is allowed to request the femtocell for image captured by the network camera by making a video telephone call to further enhancing ease of use.

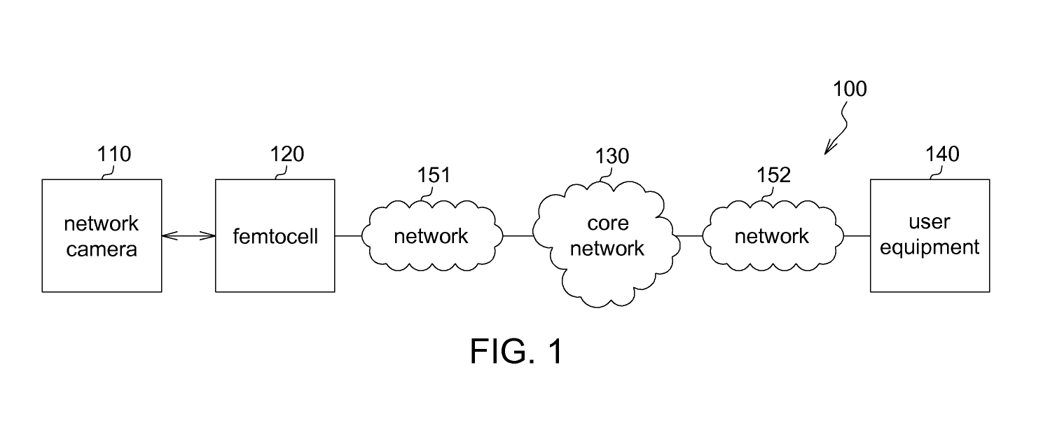

FIG. 1 shows a schematic diagram of a network system. A network system 100 in FIG. 1 includes a network camera 110, a femtocell 120, a core network 130 and a user equipment 140. For example, the communication system 100 is based on a 3^{rd} generation (3G), 4^{th} generation (4G) or the like.

For example, the network camera 110 includes a lens set, optical sensing elements and a data processing unit, and provides video photographing/transmission and still image capturing functions. For example, the network camera 110 is a network camera referred to as an IP cam or a web cam. The network camera 110 is connected to the femtocell 120 via a wire or wireless interface, for example, to obtain access services. Further, the network camera 110 has an IP address in a network 151 such as a broadband Internet network to allow other devices connected to the network 151 to identify a location of the network camera 110.

For example, the femtocell 120 is a home node-B (HNB), a home evolved node-B (HeNB), a base station capable of dialing/receiving a network telephone call, an access point or a gateway. For example, the femtocell 120 is connected to the network 151 and the core network 130 via a broadband line such as a cable line, a digital subscriber line (DSL), and/or an fiber optical line. The femtocell 120 may be disposed in a household, a school, a business unit or an enterprise to provide wireless coverage and access services.

For example, the core network 130 is a 3G, 4G or the like. The core network 130 is for example, an operator intranet connected to a wireless base station, a public switched telephone network (PSTN) or other data network. For example, the core network 130 includes an audio/multimedia data conversion system, a user information record system, a billing system, a user database or a server for user registration.

For example, the user equipment 140 includes various types of terminal equipments including a mobile phone, a computer or other equipments connectable to a network 152 of the communication system 100. In one embodiment, for example, the user equipment 140 is a mobile phone based on 3^{rd} Generation Partnership Project (3GPP), Worldwide Interoperability for Microwave Access (WiMAX), Long-Term Evolution (LTE) or the like. Further, the user equipment 140 is connected to the network 150 according to a corresponding communication protocol, such as a Radio Access Network (RAN). In another embodiment, for example, the user equipment 140 is a tablet computer, a desktop computer and/or a laptop computer that connects to the network 152 such as a broadband Internet network.

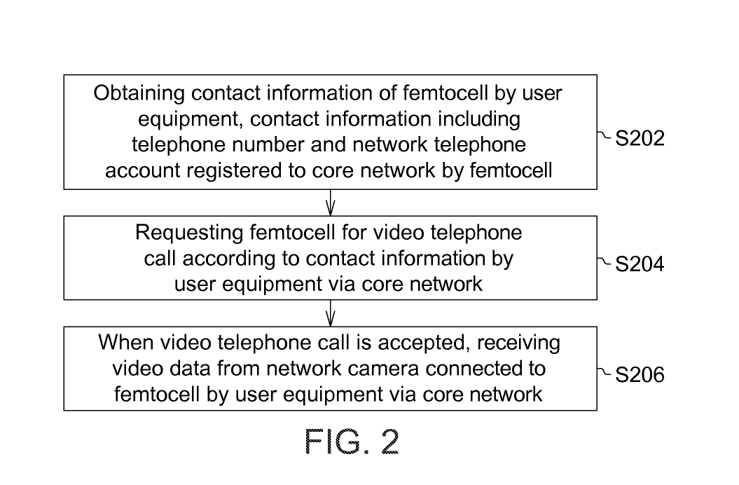

FIG. 2 shows a flowchart of a communication method according to one embodiment of the present application. The communication method of FIG. 2 is applicable to the communication system 100 shown in FIG. 1. The communication method includes several steps to be described below.

In Step S202, the user equipment 140 obtains contact information of the femtocell 120. The contact information includes a telephone number or a network telephone account registered to the core network 130 by the femtocell 120. In Step S204, the user equipment 140 requests the femtocell 120 for a video telephone call via the core network 130 according to the contact information. In Step S206, when the video telephone call is accepted, the user equipment 140 receives from the femtocell 120 video data captured by the network camera 110 connected to the femtocell 120 via the core network 130.

Accordingly, the user equipment is able to request the femtocell for images captured by the network camera by making a video telephone call to the femtocell, for further ease of use of the network camera.

Further, compared to IP address management and translation by an additional external server or a domain name system (DNS), the femtocell has a lower cost and the approach of dialing a video telephone call is more convenient and easier to remember.

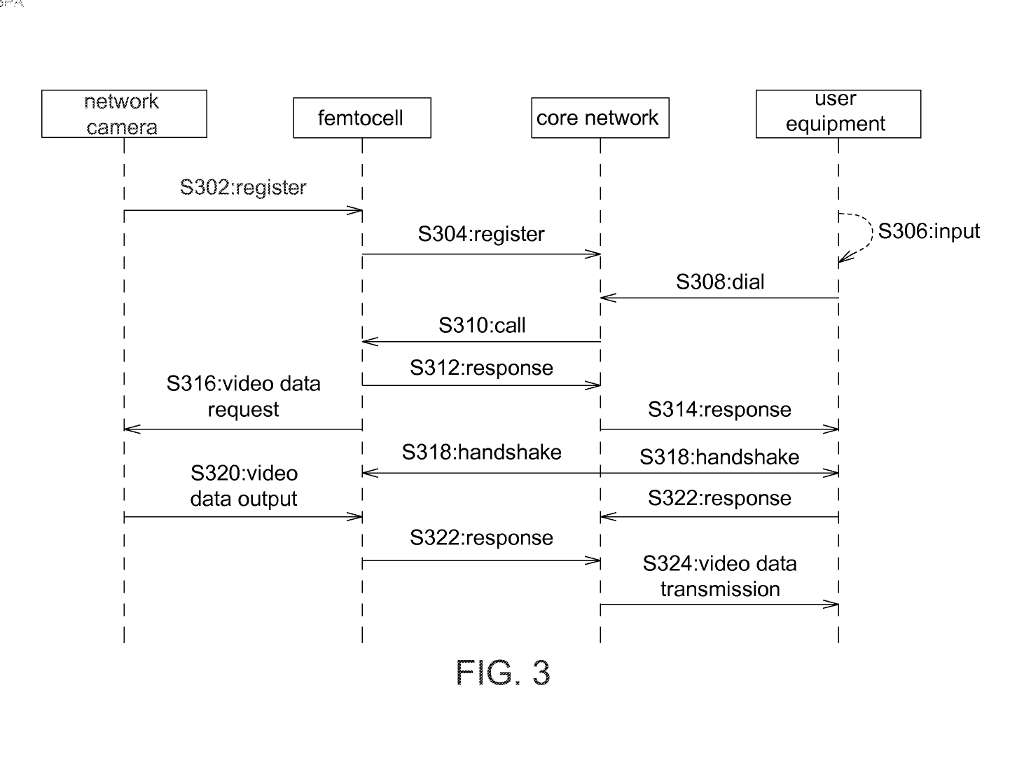

FIG. 3 shows an example of a detailed flowchart of the communication method in FIG. 2.

In this example, the user equipment 140 requests the femtocell 120 for images captured by the network camera 110 through dialing a video phone call to the femtocell 120 to enhance ease of use.

In Step S302, the network camera 110 registers to the femtocell 120. For example, the network camera 110 informs the femtocell 120 of IP address of the network camera 110 so that the femtocell 120 is well-informed about identifying or locating the network camera 110.

In Step S304, when the femtocell 120 receives a registration message (e.g., an IP address) from the network camera 110, the femtocell 120 registers to the core network 130.

In one embodiment, the femtocell 120 registers a telephone number to the core network 130. For example, the femtocell 120 is provided with a Universal Subscriber Identity Module (USIM) card, and registers to the core network 130 for a dedicated telephone number based on identification information (such as an International Mobile Subscriber Identity (IMSI) or a Temporary IMSI (TIMSI)) of the USIM card.

In another embodiment, the femtocell 120 registers to the core network 130 for a network telephone account. For example, the femtocell 120 registers to a network telephone server of the core network 130 for a dedicated network telephone account, such as a network telephone account based on Session Initiation Protocol (SIP), Skype, MSN, Yahoo, Google Talk or other network telephone servers.

After Steps S302 and S304, the femtocell 120 is ready to receive a video telephone call from the user equipment 140, to request a video telephone call to the user equipment 140 and/or to provide video data captured by the network camera 110 to the user equipment 140 after the video telephone call from the user equipment 140 is accepted and established.

Details of the user equipment 140 requesting the femtocell 120 for a video telephone call shall be given below.

In Step S306, the user equipment 140 obtains the telephone number or the network telephone account of the femtocell 120. For example, the user equipment 140 accepts a user input about a telephone number of the USIM card at the femtocell 120, or a network telephone account of the femtocell 120. Alternatively, the user equipment 140 stores a telephone book containing contact information of various contact objects, e.g., a name, a user code, an address, a telephone number, a network telephone account and/or other information to allow a user to inquire and select the telephone number or the network telephone account of the femtocell 120.

In Step S308, the user equipment 140 transmits a dial signaling to the core network 130 by the telephone number or the network telephone account of the femtocell 120. The dial signaling indicates that the user equipment 140 requests the femtocell 120 for a video telephone call.

In Step S310, the core network 130 transmits a call signaling to the femtocell 120. The call signaling from the core network 130 is for informing the femtocell 120 of the request for a video telephone call. For example, the call signaling from the core network 130 includes information (e.g., the IMSI or TIMSI of the USIM of the femtocell 120) of a call recipient or a data flow of the network telephone account. The call signaling from the core network 130 may further include information of a caller to inform the recipient of a requester of the video telephone call.

In Step S312, when the femtocell 120 receives the call signaling, the femtocell 120 transmits a response signaling to the core network 130. For example, the femtocell 120 determines whether the call signaling is to call the telephone number of the femtocell 120 USIM card or the network telephone account of the femtocell 120 according to the IMSI or TISMI in the call signaling. The response signaling from the femtocell 120 is for informing the core network 130 that the video telephone call is accepted.

In Step S314, when the core network 130 learns the femtocell 120 has accepted the video telephone call, the core network 130 transmits a response signaling to the user equipment 140. The response signaling from the core network 130 is for informing the user equipment 140 that the video telephone call is accepted.

In Step S316, when the femtocell 120 receives the call signaling, the femtocell 120 transmits a video data request signaling to the network camera 110. For example, the femtocell 120 transmits the video data request signaling to the network camera 110 according to the IP address of the network camera 110.

In Step S318, the core network 130 initiates handshake between the femtocell 120 and the user equipment 140. For example, the core network 130 initiates a user plane handshake signaling to the femtocell 120 and the user equipment 140 to process user audio and/or data services. For a 3G network, a video telephone call may be based on H245 protocol, and thus the core network 130 may complete the user plane handshake according to the H245 protocol.

In Step S320, upon receiving the video data request signaling, the network camera 110 transmits its video data to the femtocell 120. In transmission, coding of the video data may be performed by the network camera 110 or by the femtocell 120.

In Step S322, the core network 130 receives a handshake response signaling from the femtocell 120 and the user equipment 140. The handshake response signaling indicates that the handshake is accepted by both parties. At this point, the femtocell 120 may transmit the video data captured by the network camera 110 to the core network 130.

In Step S324, the core network 130 transmits the video data captured by the network camera 110 to the user equipment 140. For a 3G network, the core network 130 transmits video data according to an H263 protocol, transmits audio data according to Adaptive Multi-Rate (AMR) compression, and synchronizes video signals and audio signals according to an H223 protocol. For a 4G network, the core network 130 sends data by a SIP-based video telephone call.

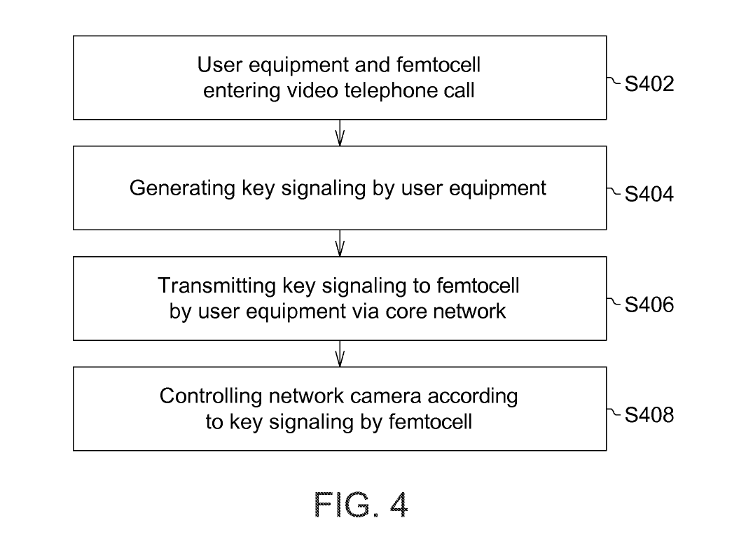

FIG. 4 shows a flowchart of a communication method according to another embodiment of the present application.

In this embodiment, the user equipment 140 controls the network camera 110 by keys or buttons during the video telephone call to enhance the ease of use of the network camera 110.

In Step S402, the user equipment 140 and the femtocell 120 enter a video telephone call. For example, the video telephone call is requested by the user equipment 140 and accepted by the femtocell 120, or is requested by the femtocell 120 and accepted by the user equipment 140.

In Step S404, the user equipment 140 generates a key signaling. For example, the key signaling is generated by a key press on the user equipment 140. Taking a mobile phone as the user equipment for example, the user equipment 140 has various keys including direction keys and numeric keys, and the key signaling is a dual-tone multi-frequency (DTMF) key signaling generated by a key press.

In Step S406, the user equipment 140 transmits the key signaling to the femtocell 120 via the core network 130.

In Step S408, the femtocell 120 controls the network camera 110 according to the key signaling. For example, the femtocell 120 converts the DTMF key signaling to a control signal, and transmits the control signal to the network camera 110 for a control operation.

During the video telephone call, the function of the key signaling of the user equipment 140 is as described below. When the user equipment 140 generates a key signaling due to press on a direction key or a numeric key, the network camera 110 may be tilted or zoomed. For example, a key signaling due to press on a numeric key “2” prompts the network camera 110 to tilt upward, a key signaling due to press on a numeric key “4” prompts the network camera 110 to rotate to the left, a key signaling due to press on a numeric key “6” prompts the network camera 110 to rotate to the right, a key signaling due to press on a numeric key “8” prompts the network camera 110 to tilt downwards, a key signaling due to press on a numeric key “6 prompts the network camera 110 to set at the center, a key signaling due to press on a numeric key “1” prompts the network camera 110 to zoom out, and a key signaling due to press on a numeric key “3” prompts the network camera 110 to zoom in. It should be noted that the key signaling of the user equipment may have other function besides the above examples during the video telephone call.

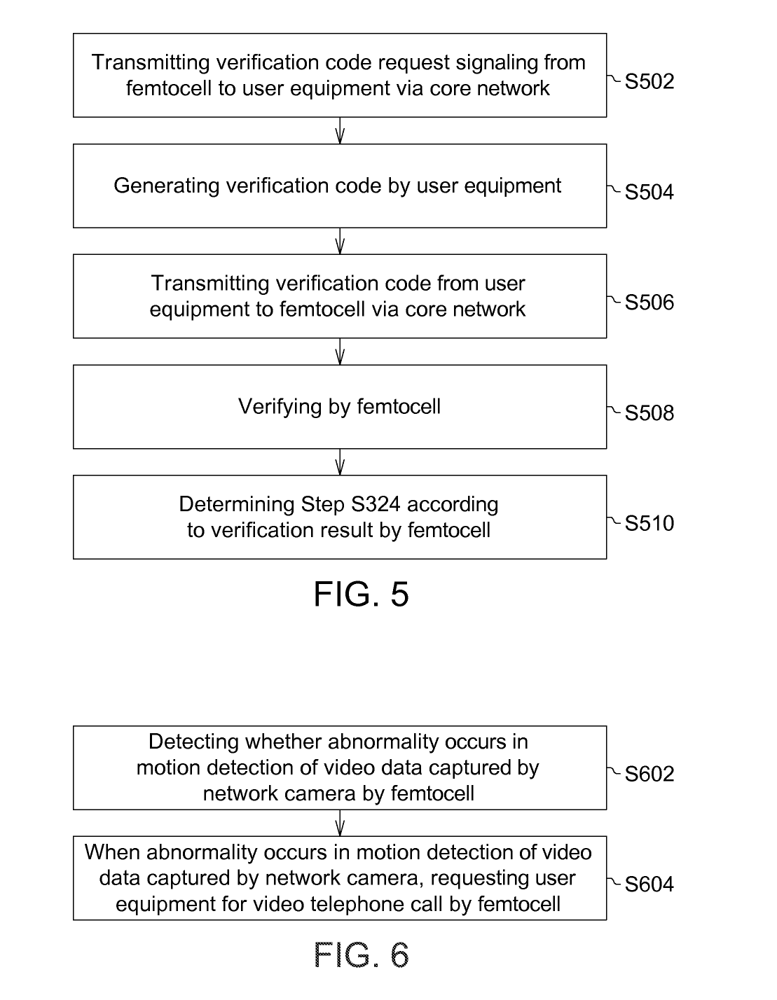

FIG. 5 shows a flowchart of a communication method according to another embodiment of the present application.

In this embodiment, for security concerns, the femtocell 120 may response to the telephone calls or the user equipment. Alternatively, when the user plane handshake is completed, the user equipment 140 obtains the video data until a predetermined sequence is satisfied, thereby reinforcing the transmission security of the video data in the network system.

In Step S502, the femtocell 120 transmits a verification code request signaling to the user equipment 140 via the core network 130.

In Step S504, the user equipment 140 generates the verification code. For example, the user equipment 140 generates the verification code as a result of a user operation. For example, the verification code is a designated or user-defined sequence, e.g., a personal pin code.

In Step S506, the user equipment 140 transmits the verification code to the femtocell 120 via the core network 130. For example, the user equipment 140 packages the verification code in the DMTF key signaling and transmits the DMTF key signaling containing the verification code.

In Step S508, the femtocell 120 verifies the verification code.

In Step S510, according to a verification result, the femtocell 120 determines Step S324. For example, when the femtocell 120 verifies that the verification code passes (i.e. the verification code is correct), the femtocell 120 grants the transmission of the video data captured by the network camera 110. When the femtocell 120 verifies that the verification code fails (i.e. the verification code is incorrect), the femtocell 120 refuses the transmission of the video data of the network camera 110. Thus, the transmission security of video data is reinforced.

In another embodiment, identification information of the user equipment 140 is set in advance at the femtocell 120, and the femtocell 120 is set to only respond to a user equipment 140 and allows video data transmission to this user equipment 140. Thus, the transmission security of video data is further reinforced.

FIG. 6 shows a flowchart of a communication method according to yet another embodiment of the present application.

A motion detection of a network camera usually sends a detection result in an electronic mail box. Base on the approach above, real-time situations of a facility under monitor cannot be acquired if a user does not immediately and constantly check the electronic mail box.

In this embodiment, when an abnormality occurs in a motion detection of video data, an alert is given through a video telephone call to real-time provide an environment alert to further reinforce the security of the facility under monitor.

In Step S602, the femtocell 120 detects whether an abnormality occurs in the motion detection of the video data of the network camera 110. For example, the motion detection is a real-time detection and tracking of a moving object by use of graphic detection techniques to provide an automatic alert and an automatic inform on a target under detect. For example, in the motion detection on the video data captured by the network camera 110, the femtocell 120 determines that an abnormality occurs in the motion detection of the video data when a large change occurs in the image.

In Step S604, when the abnormality in the motion detection of the video data of the network camera 110 is detected, the femtocell 120 requests a video telephone call to the user equipment 140 via the core network 130. For example, the femtocell 120 actively sends a video telephone call to provide an alert. When the video telephone call requested by the femtocell 120 is accepted, the femtocell 120 provides a video clip captured by the network camera 110, image(s) currently captured or previously captured by the network camera 110, text or audio messages or any combination thereof.

Therefore, compared to the approach of using an electronic mail box to send the motion detection result, the motion detection alert provided by the video telephone call in the embodiment is able to in real-time provide an environment alert to reinforce the security of a facility under monitor.

According to yet another embodiment of the present application, a computer program product is provided. For example, the computer program product includes codes. For example, the computer program product may be implemented as an application program or exist in a system code. When the program product is loaded by an electronic apparatus having a memory buffer, the electronic apparatus executes program commands for performing the method in the foregoing embodiments. Further, the computer program product may be regarded as a computer-readable storage medium storing at least one code or software module, and the program or software module is regarded as an implementation means for the computer program product. The program may be utilized to execute the above communication method. For example, the computer-readable data storage medium is an optical data storage medium, a magnetic data storage medium or firmware, or a code transmitted through a network/transmission medium (e.g., air).

Therefore, the communication method for video data disclosed by the embodiments of the present application features the advantages below.

First of all, through communication in the communication network, the ease of use of the network camera is enhanced by utilizing a telephone number of a network telephone account in substitution of an IP address of the network camera.

Secondly, the ease of use of the network camera is further increased by controlling the network camera through the key press of the user equipment.

Further, the transmission security of video data in the network system is reinforced by use of the verification code.

Last but not the least, by use of the motion detection alert through a video telephone call, a real-time environment alert is provided to further reinforce the security of a facility under monitor.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A communication method for video data, comprising:
obtaining contact information of a femtocell by a user equipment, the contact information comprising a telephone number or a network telephone account registered to a core network by the femtocell;
requesting the femtocell to serve for a video telephone call according to the contact information by the user equipment via the core network; and
when the video telephone call is accepted, receiving video data captured by a network camera connected to the femtocell via the core network.

2. The method according to claim 1, wherein the telephone number corresponds to identification information of a Universal Subscriber Identity Module (USIM) card of the femtocell.

3. The method according to claim 1, wherein the network telephone account is based on a Session Initiation Protocol (SIP) or Skype.

4. The method according to claim 1, further comprising:
when the video telephone call is accepted, generating a key signaling from the user equipment by a key press on the user equipment; and
transmitting the key signaling from the user equipment to the femtocell via the core network, so that the femtocell controls the network camera according to the key signaling.

5. The method according to claim 1, further comprising:
receiving a verification code request signaling from the femtocell to the user equipment via the core network; and
transmitting a verification code from the user equipment to the femtocell via the core network, so that the femtocell allows transmission of the video data captured by the network camera.

6. The method according to claim 1, further comprising:
receiving by the user equipment another video telephone call requested by the femtocell via the core network, the another video telephone call for alerting an abnormality in a motion detection of the video data captured by the network camera.

7. A communication method for video data, comprising:
receiving by a femtocell a video telephone call requested by a user equipment via a core network, the user equipment requesting the femtocell for the video telephone call according to contact information of the femtocell, the contact information comprising a telephone number or a network telephone account registered to the core network by the femtocell;
receiving the video telephone call by the femtocell; and
when the video telephone call is accepted, transmitting video data captured by a network camera connected to the femtocell to the user equipment by the femtocell via the core network.

8. The method according to claim 7, wherein the telephone number corresponds to identification information of a USIM card of the femtocell.

9. The method according to claim 7, wherein the network telephone account is based on a Session Initiation Protocol (SIP) or Skype.

10. The method according to claim 7, further comprising:
when the video telephone call is accepted, receiving a key signaling from the user equipment by the femtocell via the core network, the key signaling generated by press on a plurality of keys of the user equipment; and
controlling the network camera according to the key signaling by the femtocell.

11. The method according to claim 7, further comprising:
transmitting a verification code request signaling to the user equipment by the femtocell via the core network; and
after the femtocell receives a correct verification code, granting transmission of the video data captured by the network camera.

12. The method according to claim 7, further comprising:
detecting whether an abnormality occurs in a motion detection of the video data captured by the network camera by the femtocell; and
when the abnormality in the motion detection of the video data captured by the network camera occurs, requesting the user equipment for another video telephone call by the femtocell via the core network.
